(19) United States
(12) Patent Application Publication
(10) Pub. No.: US 2008/0287182 A1
(43) Pub. Date: Nov. 20, 2008

(54) Gaming machine and gaming system

(75) Inventor: Eiji Aida, Zama (JP)

Correspondence Address: GLOBAL IP COUNSELORS, LLP, 1233 20TH STREET, NW, SUITE 700, WASHINGTON, DC, 20036-2680, US

(73) Assignee: Konami Gaming, Incorporated, Las Vegas, NV (US)

(21) Appl. No.: 11/798,421

(22) Filed: May 14, 2007

(51) Int. Cl. A63F 9/24; G06F 17/00

(52) U.S. Cl. 463/25

(57) ABSTRACT

A storage interface unit can exchange player's individual information with an external storage device placed on a gaming machine. An individual information manager unit uses the individual information in player identification or as credits. A game control unit executes a game program and thereby conducts a game. An alarm unit monitors the connection between the storage interface unit and the storage device, or the presence or absence of the storage device on the gaming machine. The alarm unit outputs a warning message or signal indicating that the storage device is still positioned where it can communicate with the storage interface unit. The warning message or signal is outputted, for example, when the game control unit has received from the player the instruction to convert his/her credits into cash or monetary information to be stored in the storage device, or when the player's credits have been reduced to zero.

### BACKGROUND OF THE INVENTION

1. Field of the Invention

The present invention relates to gaming machines and systems, in particular, those capable of data exchange with external storage devices placed on the gaming machines.

2. Background Information

A gaming machine is known that can exchange data, e.g., individual or monetary information of a player or game data, with an external storage device, e.g., a magnetic card, a memory card, an IC card, or a mobile phone. Such a type of gaming machine is installed in an amusement arcade, a pachinko parlor, or a casino, or intended for home use.

For example, there is a gaming machine installed especially in a casino that is used to provide players with a number of points depending on the money that they have spent for game play in the casino. Each player is issued a house card before game play in exchange for registration to a server in the casino. The house card is a portable storage device usable within the casino. The house card stores identification data of itself (card ID) or the player (player ID). The player first inserts his/her house card into a card slot mounted on the gaming machine at the start of game play. The gaming machine then reads the card/player ID from the house card, and uses it to increase the player's points stored in a server depending on the game play. The server thus keeps track of a total number of players' points. The player can be provided with bonuses such as free accommodation coupons, depending on the total number of points.

Another gaming machine, especially a pachinko machine installed in a pachinko parlor, allows a prepaid card to be used in game play. The gaming machine uses a card slot to read the monetary information from the prepaid card, and uses the player's money indicated by the monetary information in game play (e.g., allows the player to use a number of pachinko balls).

A gaming machine, especially installed in an amusement arcade or a home, gaming machine allows a memory card to save game data for the next game play. The player first places his/her memory card on a holder mounted on the gaming machine at the start of the next game play. The gaming machine then reads the game data from the memory card, and uses it to restart the game from where the player previously stopped.

In recent years, application of a noncontact IC card system to gaming machines is under development. This application aims to use an IC card as a house card, a prepaid card, and a memory card on gaming machines. An IC card has a larger storage capacity than a magnetic card, and allows a card reader/writer to exchange data while retaining a higher level of security. This can enhance the flexibility and variety in functional design of gaming machines. Moreover, a gaming machine can exchange data with an IC card in a wireless manner. This facilitates simplifying the structures of a card slot or holder. In particular, a card reader/writer may be installed in a pad mounted on a gaming machine, and an IC card may be simply placed over or on the pad. Thus, the application of a noncontact IC card system can enhance the operability of gaming machines.

In addition, there is a mobile device, e.g., a mobile phone and a PDA, with a built-in noncontact IC card function. On the other hand, there is a pad that can wirelessly provide power to a mobile device placed thereon, as well as wirelessly communicate with the IC card function thereof. Accordingly, the installation of this type of pad may enhance service of the gaming machines provided to players during game play, e.g., a service of charging a mobile phone and the like, or a service of allowing a player to watch a TV program or the like on the screen of a mobile phone or portable DVD player.

On disadvantage of the application of a noncontact IC card system to gaming machines is that some players absorbed in games tend to carelessly leave their own IC cards and the like on the gaming machines when they have lost all of their credits, or when they have won a jackpot. IC cards, in particular, mobile phones and PDAs, are valuable and further have monetary and individual information of the players. Accordingly, gaming machines need a function of preventing players from carelessly leaving their own IC cards and the like at the gaming machines.

In view of the above, it will be apparent to those skilled in the art from this disclosure that there exists a need for an improved gaming machine that reduces the risk of players carelessly leaving their IC cards and the like thereon. This invention addresses this need in the art as well as other needs, which will become apparent to those skilled in the art from this disclosure.

### SUMMARY OF THE INVENTION

According to the present invention, a gaming machine is provided which includes a storage interface unit, an individual information manager unit, a game control unit, and an alarm unit. The storage interface unit is configured to communicate with an external storage device placed on the gaming machine to exchange individual information of a player. The storage interface unit preferably comprises a pad, a slot, or a holder, and is configured to communicate with the external storage device that is placed thereon or therein. The individual information manager unit is configured to use an item of the individual information in identification of the player, or as monetary information relating to game play. The game control unit is configured to execute a game program, and thereby control game functions depending on the data that the player has entered into the gaming machine. The game control unit is also configured to change the monetary information depending on the game result. The alarm unit is configured to output a warning message or signal indicating that the external storage device is still positioned where it is allowed to communicate with the storage interface unit. In the case where the storage interface unit communicates with the external storage device that is placed on a pad or in a slot or a holder, the alarm unit is preferably configured to monitor the connection between the storage interface unit and the external storage device, or the presence or absence of the external storage device on the pad or in the slot or the holder. The alarm unit is further configured to output the warning message or signal depending on the game status or in response to a specific signal that the game control unit has received from the player. Accordingly, the warning message or signal can be provided to a player or a casino attendant at the appropriate time, especially when it is likely that the player will carelessly leave his/her storage device on the gaming machine. Thus, the gaming machine can effectively reduce the risk of losing players' storage devices without bothering the players with unnecessary displays of warning messages and signals.

The alarm unit is preferably configured to output the warning message or signal when the game control unit has received from the player the instruction to convert his/her credits into cash or the monetary information to be stored in the external storage device, or when the game control unit has finished the conversion from the credits into cash or the monetary information. The conversion is usually performed when the player will quit game play on the gaming machine. Accordingly, the warning message or signal can be provided to a player or a casino attendant when the player will quit the game play and leave the gaming machine.

The alarm unit is preferably configured to output the warning message or signal in one of the following cases: when the game control unit detects that the player's credits have been reduced to zero at the end of a game; when the game control unit has received no additional credits from the player for a predetermined time after detecting that the credits were reduced to zero; and when the game control unit has received from the player the instruction to quit game play on the gaming machine after detecting that the credits were reduced to zero. There is a high probability that the player will quit game play and leave the gaming machine in the above-mentioned cases. Accordingly, the warning message and signal are effective.

For a similar reason, the alarm unit may be configured to output the warning message or signal in one of the following cases: when the game control unit detects that the player's credits have been reduced below a minimum bet at the end of a game; when the game control unit has received no additional credits from the player for a predetermined time after detecting that the credits were reduced below the minimum bet; and when the game control unit has received from the player the instruction to quit game play on the gaming machine after detecting that the credits were reduced below the minimum bet.

The alarm unit is preferably configured to output the warning message or signal when the game control unit has received from the player the instruction to suspend game play on the gaming machine. The instruction is usually entered in the gaming machine when the player will take a break from the gaming machine. Accordingly, the warning message and signal are effective.

The alarm unit is preferably configured to output the warning message or signal when the game control unit has determined to provide the player with a jackpot or an award larger than a predetermined amount. Alternatively, when the gaming machine is connected to an external jackpot controller, the alarm unit is preferably configured to output the warning message or signal when the jackpot controller has determined to provide the player with a jackpot. In such cases, it is likely that the player goes into transports of delight. If not so, there is a high probability that the player will find satisfaction in winning the jackpot or the award, and quit game play on the gaming machine. Accordingly, the warning message and signal are effective. Especially when the gaming machine comprises a display unit, and the game control unit is preferably configured to display a credit meter on the display unit, the alarm unit is preferably configured to output the warning message or signal in one of the following cases: when the game control unit increases the credit meter by the amount of the jackpot or the award; when the game control unit has finished the increase of the credit meter; and when the game control unit has received from the player no instruction for a predetermined time after the game control unit has started or finished the increase of the credit meter.

The alarm unit is preferably configured to output the warning message or signal when the game control unit receives from the player a predetermined type of intervention. The types of interventions preferably include the action that indicates the player's annoyance, e.g., striking a button repeatedly, accelerating a play time per round, and skipping the display of messages. More preferably, the alarm unit is configured to output the warning message or signal when the game control unit receives the intervention a predetermined number of times within a fixed time period, or when the game control unit detects both the intervention and the amount of the player's credit that has been reduced below a lower limit. When such a type of intervention has occurred frequently or at a time of short credits, there is a high probability that the player intends to quit game play and leave the gaming machine. Accordingly, the warning message and signal are effective.

The alarm unit is preferably configured to output the warning message or signal when the storage interface unit maintains the connection with the external storage device active for a predetermined time. When the predetermined time has elapsed from the start of game play, there is a higher probability that the player will quit game play and leave the gaming machine. Accordingly, the warning message and signal are effective. In this case, the alarm unit is more preferably configured to output the warning message or signal when the game control unit has received from the player no instruction for the predetermined time. Under this condition, the player is probably dozing over a game. Accordingly, the warning message and signal are effective. Note that the alarm unit or the game control unit may leave the time period of playing feature or bonus games out of measuring the elapsed time.

The alarm unit is preferably configured to output the warning message or signal when the storage interface unit has detected an error in the communication with the external storage device and the game control unit has received from the player no instruction for a predetermined time after the detection of the error. Under this condition, the player is probably unaware of the error in the external storage device. In this case, it is likely that the player will carelessly leave his/her storage device on the gaming machine. Accordingly, the warning message and signal are effective.

The alarm unit is preferably configured to output the warning message or signal when the game control unit has been forced to terminate a game because of an error. Under this condition, the player usually has no other choice but to leave the gaming machine. Accordingly, the warning message and signal are effective.

The gaming machine may comprise a human sensor or a player monitoring unit comprising a camera and an image processor. In this case, the alarm unit is preferably configured to determine whether to output the warning message or signal depending on the position of the player detected by using the human sensor or the player monitoring unit. In particular, the alarm unit is configured to output the warning message or signal when the player is absent in front of or around the gaming machine, or when the player are some distance from the gaming machine. This is effective in quickly notifying the player or a casino attendant of carelessly leaving the player's storage device on the gaming machine.

The alarm unit is preferably configured to output the warning message or signal by using a display unit or a speaker, or change the brightness and color of a lighting unit in specific patterns that indicates the warning signal. Here, the gaming machine preferably comprises the display unit, the speaker, or the lighting unit. Alternatively, the gaming machine may be externally connected to the display device, the speaker, or the lighting device. In this case, the display device, the speaker, and the lighting device are preferably placed at an exit of a floor where the gaming machine is installed. In addition, the gaming machine may be connected to an external network, and the alarm unit may be configured to transmit the warning message or signal to a specific device through the network. The specific device preferably includes a server installed in a casino and a mobile device that a casino attendant owns. This allows the attendant to quickly pick up the storage device left on the gaming machine.

The gaming machine may further comprise a ticket reader unit and a ticket printer unit. The ticket reader unit is configured to receive a ticket from a player, and decode monetary information from data printed on the ticket. The ticket printer unit is configured to print data indicating monetary information on a new ticket or the ticket received in the ticket reader unit. In this case, the alarm unit is preferably configured to transmit the warning message or signal to the ticket printer unit, and the ticket printer unit is preferably configured to print the warning message or a specific symbol as the warning signal on the new ticket or the ticket received in the ticket reader unit. The player hardly forgets the ticket when he/she will leave the gaming machine. Accordingly, the warning message and signal printed on the ticket are effective.

The alarm unit is preferably configured to stop outputting the warning message and signal when the storage interface unit has cut off the connection with the external storage device. This allows the alarm unit not only to reduce the power consumption, but also to prevent the unnecessary warning messages and signals from bothering a player.

The alarm unit is preferably configured to use the individual information to output the warning message or signal. For example, the warning message or signal may include a targeted player's name or face photograph. If the storage device has the function of receiving a phone call or email from a network, the alarm unit may send the warning message or signal to the storage device through the network. Otherwise, the alarm unit may send the warning message or signal to the mobile phone of a player by phone or email.

The gaming machine may be of a standalone type or a download type. The download-type gaming machine is connected to a server. The server preferably comprises a memory unit configured to store a game program. In this case, the game control unit is preferably configured to download a game program from the memory unit and execute the game program, and thereby control game functions.

The present invention may be applied to a thin-client-type gaming system. The gaming system preferably comprises a server and a gaming machine that are configured to communicate each other.

The server preferably comprises an individual information manager unit and a game control unit. The individual information manager unit is preferably configured to use an item of the individual information of a player who plays a game on the gaming machine in identification of the player, or as monetary information relating to game play. The game control unit is preferably configured to execute a game program, and thereby conduct a game on the gaming machine as follows. The game control unit receives instructions and input data from the gaming machine that has received from the player. The game control unit then provides the gaming machine with commands and output data to control game functions thereof depending on the instructions and input data. The game control unit further changes the monetary information depending on the game result.

The gaming machine preferably comprises a storage interface unit, a server interface unit, and an alarm unit. The storage interface unit is preferably configured to communicate with an external storage device to exchange the individual information of the player. The server interface unit is preferably configured to transmit the individual information and the instructions and input data to the game control unit, and receive the commands and output data from the game control unit. The server interface unit thereby causes the gaming machine to perform game functions depending on the commands and output data. The alarm unit is preferably configured to output a warning message or signal indicating that the external storage device is still positioned where it is allowed to communicate with the storage interface unit, depending on the game status or in response to a specific signal that the game control unit has received from the player. In particular, the gaming system preferably comprises a display device, a speaker, or a lighting device connected to the gaming machine. In this case, the alarm unit is preferably configured to output the warning message or signal by using the display device or the speaker, or change the brightness and color of the lighting device in specific patterns that indicates the warning signal.

These and other objects, features, aspects and advantages of the present invention will become apparent to those skilled in the art from the following detailed description, which, taken in conjunction with the annexed drawings, discloses a preferred embodiment of the present invention.

### BRIEF DESCRIPTION OF THE DRAWINGS

Referring now to the attached drawings which form a part of this original disclosure:

FIG. 1 is a network diagram of a gaming system according to an embodiment of the present invention;

FIG. 2 is a front view of a gaming machine shown in FIG. 1;

FIGS. 3A-3C are schematic diagrams that shows external storage devices placed on a pad shown in FIG. 2;

FIG. 4 is a block diagram of the gaming machine shown in FIG. 1;

FIG. 5 is another block diagram of the gaming machine and the server shown in FIG. 1;

FIG. 6A is an example of a game screen displayed on the gaming machine shown in FIG. 2; and

FIG. 6B is an example of a warning message displayed on the game screen shown in FIG. 6A.

### DETAILED DESCRIPTION OF THE PREFERRED EMBODIMENTS

A preferred embodiment of the present invention will now be explained with reference to the drawings. It will be apparent to those skilled in the art from this disclosure that the following description of the preferred embodiment of the present invention is provided for illustration only and not for the purpose of limiting the invention as defined by the appended claims and their equivalents.

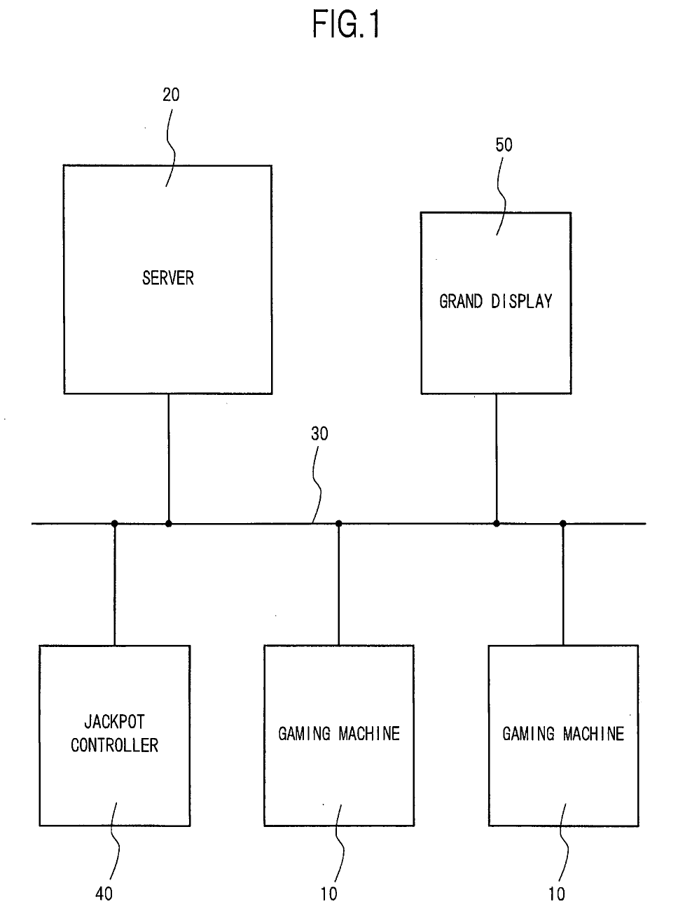

According to a preferred embodiment of the present invention, a gaming system is preferably installed in a casino. Referring to FIG. 1, the gaming system includes one or more gaming machines 10 and a server 20, which are connected to each other through a LAN 30. The gaming machines 10 are preferably placed on floors on the casino. The server 20 is preferably placed in a security room, which is off-limits to players and is locked by casino managers. The gaming system may further include a jackpot controller 40 and a grand display 50, which are also connected to the LAN 30. The jackpot controller 40 is preferably placed on the casino floor or installed in one of the gaming machines 10. The grand display 50 is preferably placed on a wall or at an exit of the casino floor.

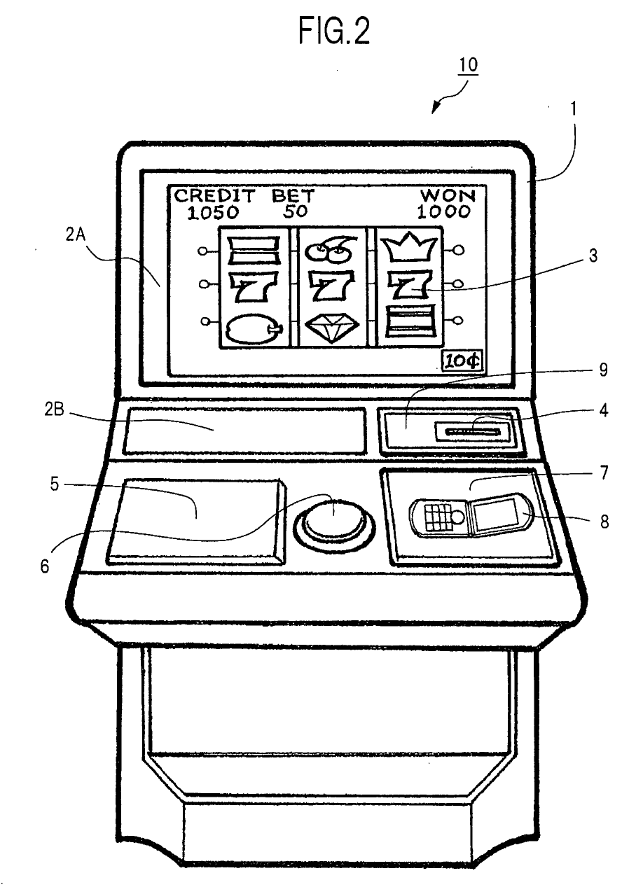

Each gaming machine 10 is preferably a video slot machine, for example, as shown in FIG. 2. Alternatively, the gaming machine 10 may be a slot machine with mechanical reels, a poker machine, a roulette machine, or other types of video or mechanical gaming machines. The gaming machine 10 preferably comprises a box-shape cabinet 1, two display windows 2A and 2B, a ticket slot 4, a touch panel 5, a spin button 6, and a pad 7. The two display windows 2A and 2B are preferably provided on upper and middle portions of a front of the cabinet 1, respectively. The ticket slot 4 is preferably mounted on the middle portion of the front of the cabinet 1. The cabinet 1 preferably includes an overhanging portion on the front. The touch panel 5, the spin button 6, and the pad 7 are mounted on the overhanging portion. Note that the gaming machine 10 may also comprise coin/bill slots, a coin chute, and/or a coin tray.

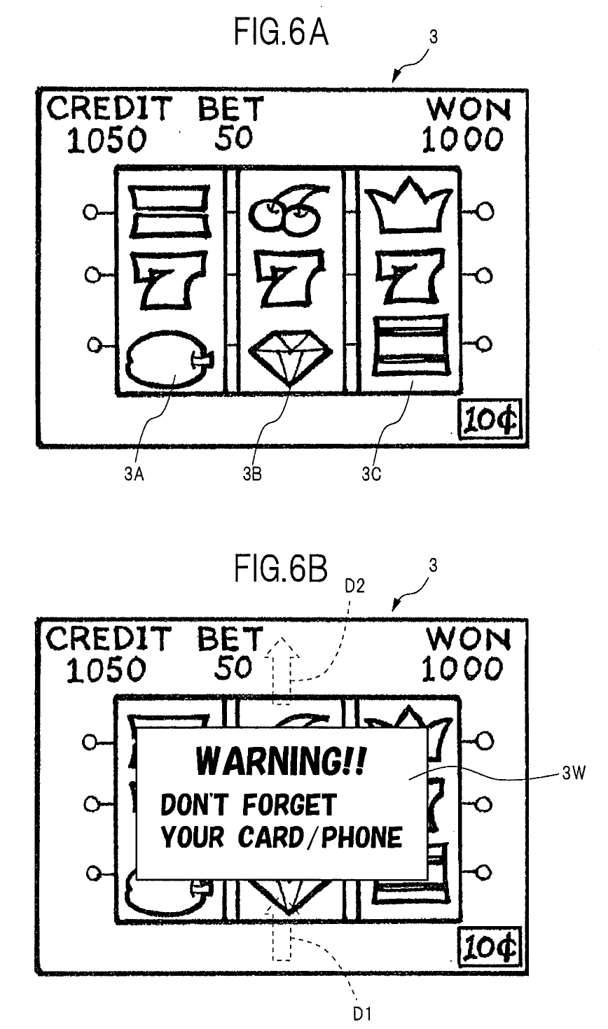

The two display windows 2A and 2B include a flat panel display device (e.g., an LCD, a PDP, or an OLED). The main display window 2A displays a game screen 3 that has three, for example, symbol columns or video reels 3A, 3B, and 3C on a graphic form, as shown in FIGS. 2 and 6A. Three symbols are preferably displayed on each video reel 3A-3C to provide a 3×3 symbol matrix appears on the game screen 3. The game screen 3 varies in pattern depending on game status. In particular, various symbols move in a vertical direction on each video reel 3A-3C, and then the matrix of stopped symbols varies in arrangement, like symbols displayed on the circumferential surfaces of mechanical reels that repeat spins and stops. The game screen 3 also includes three types of meters showing the number of available credits, a bet, and a payout that a player has won. The sub-display window 2B preferably displays specific items of individual information of a player. The items preferably include the player's name and/or photograph, and the number of points provided to the player depending on the money that he/she has spent in the casino. The two display windows 2A and 2B may display other various types of images, e.g., images for use in decoration such as the logo of a game developer, images for use in advertisements, images for use in visual effects in games, and visualized information on games such as pay tables, illustrations of game content, and jackpot values.

The ticket slot 4 accepts a specific ticket from a player. The ticket is preferably a piece of paper or a plastic card. The number of credits and a bar code are printed on a surface of the ticket. The bar code indicates the number of credits. When a player has entered the ticket into the ticket slot 4, a ticket reader installed in the ticket slot 4 decodes the number of credits from the bar code. Then, the decoded number appears on the display window 2A or 2B as the number of credits available to the player. When a player has instructed the gaming machine 10 to pay his/her credits by a ticket, a ticket printer, installed in the ticket slot 4, produces a new ticket or overwrites the inserted ticket. On the ticket, the number of player's credits is printed in numerals and in a bar code.

Note that the gaming machine 10 may use a money counter, a money accepter, and/or a money hopper to accept coins and bills from a player and pay credits to him/her in cash. In this case, the gaming machine 10 may display the number of credits equivalent to the total amount of the coins and bills on the display window 2A or 2B.

The touch panel 5 and the spin button 6 constitute a main input device of the gaming machine 10, which accepts various kinds of instructions from a player, in particular, instructions to change game status. The touch panel 5 preferably displays a matrix of virtual buttons each assigned to a specific function of the gaming machine 10. The touch panel 5 detects the position at which a player touches, and then identifies the function assigned to the virtual button that is displayed at the detected position. A player selectively touches virtual buttons to enter various instructions, such as to select paylines, the amounts of bets to be placed on the selected paylines, instruct to pay his/her credits, or suspend and quit his/her game play. Alternatively, a keyboard image and a numeric keypad image may be displayed on the touch panel 5, thereby allowing a player to freely enter characters and numerals. The spin button 6 is a large push button, and accepts a cue from a player for the video reels 3A-3C to start spinning. The spin button 6 is preferably a lamp button equipped with an internal light emitting device. Note that push buttons such as bet buttons and a cash-out button may be mounted on the cabinet 1 instead of or in addition to the touch panel 5.

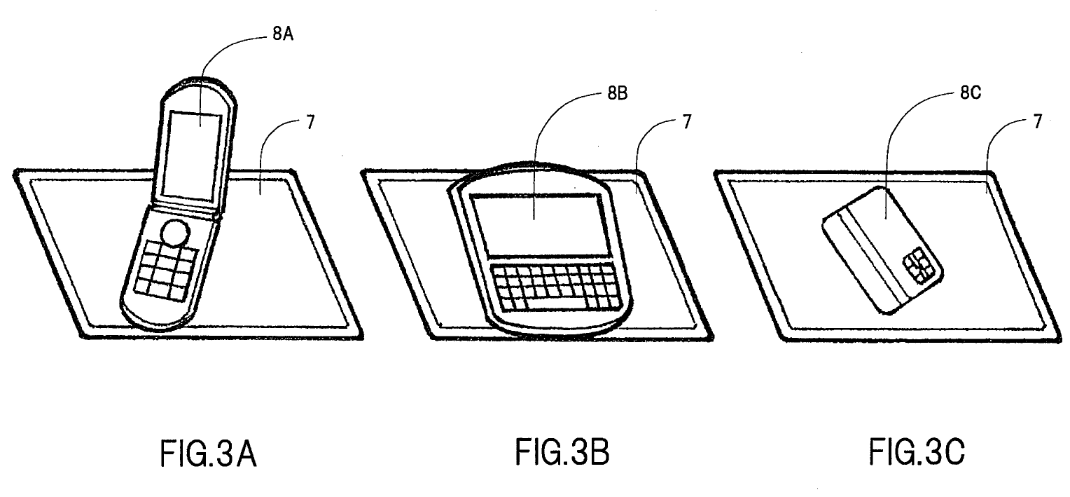

The pad 7 is preferably a flat panel, and comprises a card reader/writer embedded therein. When an external electronic device or storage device 8 with a noncontact IC card function is placed on or near the pad 7, the card reader/writer wirelessly communicates with the storage device 8. The storage device 8 includes a storage device, such as a mobile phone 8A, a PDA 8B, or an IC card 8C (cf., FIGS. 3A, 3B, and 3C, respectively). These types of storage devices 8A, 8B, and 8C serve as an intelligent house card, prepaid card, or memory card because of their larger storage capacities and capabilities of data exchange with a higher level of security.

More specifically, the storage device 8 is used as a house card to enter identification data into the gaming machine 10. Here, the identification data preferably includes a specific ID code that is assigned to each storage device 8 or each player, and stored in the storage device 8 in advance in exchange for registration of the player's individual information to the server 20. The individual information preferably includes the player's name, photograph, and the total number of points. The server 20 links the identification data to the individual information of registered players, and uses the identification data to retrieve the individual information from databases. In particular, the server 20 keeps track of the total number of points to be provided to each player by using the identification data.

The storage device 8 can be also used as a prepaid card to increase credits stored in the gaming machine 10, i.e., to enter monetary information to be used as additional credits into the gaming machine 10. In this case, the monetary information is preferably stored in the storage device 8 by using a specific kiosk terminal on the LAN 30. In this case, the server 20 keeps track of revision histories of the monetary information stored in the storage devices 8. Alternatively, the storage device 8 has capabilities for accessing an external network, e.g., a telephone network or the Internet. The storage device 8 generates the monetary information by using a credit-card or debit-card system through the external network, i.e., by borrowing money from a credit card issuer or removing money from the player's account. In this case, the server 20 records the monetary information entered in the gaming machine 10, together with the individual information of the player. The casino will use the monetary and individual information to receive the charge indicated by the monetary information from the credit card issuer or the player's account.

The storage device 8 can also be used as a memory card to save game data (e.g., the current number of available credits, and the type, status, and round number of the current game) for the next game play. When a player suspends or quits game play on the gaming machine 10, the player saves game data to the storage device 8 on the pad 7. At the start of the next game play on either the same gaming machine 10 or another, the storage device 8 placed on the pad 7 enters the saved game data. Then, the gaming machine 10 uses the game data to restart a new round of the game under the conditions at the time the player stopped the game on the previous gaming machine 10.

The pad 7 can thus enhance the flexibility and the variety in functional design of the gaming machine 10. Moreover, the pad 7 allows the storage device 8 to be simply placed thereon. Thus, the pad 7 can enhance the operability of the gaming machine 10. In particular, the pad 7 can wirelessly supply power to a mobile phone 8A and a PDA 8B during game play in order to charge the mobile phone 8A and the PDA 8B, or allow a player to watch a TV program or the like on the screen of the mobile phone 8A or the PDA 8B. Note that the pad 7 may be replaced with a specific slot or holder that can hold the storage device 8 in a more stable manner than the pad 7.

The gaming machine 10 further includes a camera 9, which is preferably mounted on the middle portion of the front of the cabinet 1 (cf. FIG. 2). The camera 9 is preferably a CCD or a CMOS sensor, which captures objects, such as a player in front of or around the gaming machine 10, and thereby serves as a human sensor. The gaming machine 10 may comprise another type of human sensor that detects the presence or absence of a player, and the position of the player.

The gaming machine 10 further includes a lighting unit (not shown in figures) on the top or side of the cabinet 1. The lighting unit is used mainly as a signal for informing a casino attendant of a request for change or an error. Alternatively, the lighting unit is provided as decoration and visual effects in games. The lighting unit can blink and/or change brightness and color in specific patterns.

The gaming machine 10 also has a speaker (not shown in figures) preferably installed inside the cabinet 1. The speaker produces voice announcements and sound effects during games.

The jackpot controller 40 is linked to one or more gaming machines 10. The jackpot controller 40 uses a lottery process independent of a lottery process in any gaming machine 10, and thereby determines whether or not to provide a jackpot to one of the linked gaming machines 10. When the jackpot controller 40 is of a progressive type, the jackpot controller 40 monitors each bet placed on the linked gaming machines 10, and repeatedly increments a jackpot value by a percentage of each bet until a jackpot is won on one of them.

The grand display 50 is preferably a flat panel display device (e.g., an LCD or a PDP) with an extremely large screen, or alternatively, may be a group of display devices. The grand display 50 receives and reproduces various image data from the gaming machines 10, the server 20, and the jackpot controller 40 through the LAN 30. The images preferably include a guide and map of the casino floor, an operating status of each gaming machine 10, and current jackpot values. The grand display 50 may include a lighting unit and/or a speaker, like the gaming machine 10.

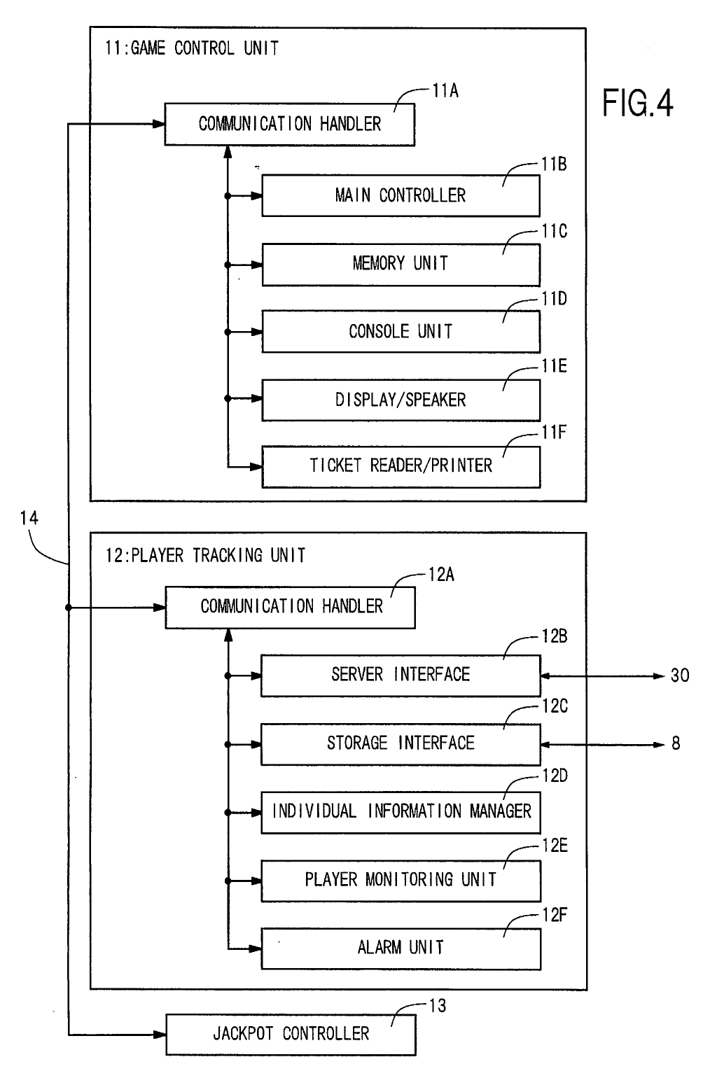

The gaming machine 10 is preferably of a standalone type or a download type, i.e., equipped with a game control unit 11 as shown in FIG. 4. The gaming machine 10 further includes a player tracking unit 12 and a jackpot controller unit 13. These units 11, 12, and 13 are preferably implemented in a separate control board, and communicate with each other through an internal bus 14 by using respective communication handlers 11A and 12A. Note that two or more of the units 11, 12, and 13 may be integrated into the same control board.

The game control unit 11 executes a game program, and thereby controls game functions as well as visual/sound effects depending on the data that a player has entered into the gaming machine 10. The game control unit 11 also changes credits depending on the game result, and increases points depending on the money that a player has spent for game play.

Referring to FIG. 4, the game control unit 11 includes the communication handler 11A, a main controller 11B, a memory unit 11C, a console unit 11D, a display/speaker driver 11E, and a ticket reader/printer driver 11F. The communication handler 11A connects other components 11B-11F to the internal bus 14. The main controller 11B executes a game program, and thereby conducts a game and controls other components 11A, 11C-11F as well as a lighting unit if installed, depending on the game status. The memory unit 11C stores a game program, credit data indicating the number of credits available to a player, and point data indicating the number of points to be provided to the player. The memory unit 11C also provides a work space for the main controller 11B. In the standalone type, the main controller 11B preferably invokes a game program from the memory unit 11C. In the download type, the main controller 11B first transfers a targeted game program from a memory unit of the server 20 to the memory unit 11C through the LAN 30, and then invokes the game program from the memory unit 11C. The main controller 11B further resets credit data and point data in the memory unit 11C on the basis of data received from the ticket reader or the player tracking unit 12. The console unit 11D controls the touch panel 5 and the spin button 6. The console unit 11D accepts instructions from a player through the touch panel 5 or the spin button 6. The main controller 11B operates other components and changes game status in response to the instructions. The display/speaker driver 11E preferably controls the display windows 2A and 2B, the display included in the touch panel 5, and the speaker. The ticket reader/printer driver 11F controls the ticket reader/printer installed in the ticket slot 4 to decode the number of credits from the bar code on a ticket, and print various information (in particular, numerals and a bar code indicating the number of credits) on a ticket.

The game control unit 11 preferably conducts a game in the following steps.

First, the console unit 11D displays virtual bet buttons on the touch panel 5. A player then uses the virtual bet buttons 5 to select paylines and enter the amount of bets to be placed. Here, paylines are preferably selected from three rows (and two diagonals) of the 3×3 symbol matrix on the video reels 3A-3C (cf. FIG. 6A). The console unit 11D accepts bet data (indicating the selected paylines and the amount of the bets) from the positions detected by the touch panel 5. Then, the main controller 11B accesses the memory unit 11C and updates credit data stored therein to decrease credits by the amounts of the bets. The main controller 11B further causes the display driver 11E to update a game screen 3, in particular the amount of the bet, on the main display window 2A.

Next, the main controller 11B causes the console unit 11D to enable the spin button 6. When the player pushes the spin button 6, the console unit 11D detects the push, and transmits a spin signal to the main controller 11B. In response to the spin signal, the main controller 11B causes the display driver 11E to display symbols moving in a vertical direction, i.e., spin the video reels 3A-3C on the main display window 2A.

At the same time, the main controller 11B generates three random numbers, and uses them in a determination of the stop positions of the video reels 3A-3C. More specifically, the main controller 11B retrieves symbols linked to the three random numbers from respective “stopped symbol tables”, which are preferably stored in the memory unit 11C. The stopped symbol tables represent links between random numbers and symbols on the video reels 3A-3C. The main controller 11B then determines the stop positions of the video reels 3A-3C where the retrieved symbols will be visible at the center of each video reel 3A-3C (cf. FIG. 6A).

Furthermore, the main controller 11B performs a lottery process to determine whether or not to provide an award to a player. More specifically, the main controller 11B first retrieves the combination of the three random numbers from a “winning combination table”, which is preferably stored in the memory unit 11C. The winning combination table represents links between combinations of three random numbers and awards. The types of awards preferably include payouts and rights to play a special game such as an event, a bonus game, a feature game, or the like. Each award is linked to a combination of three random numbers in the winning combination table. Each of the random numbers is linked to a symbol in one of the stopped symbol tables. Accordingly, each award is linked to a specific arrangement (i.e., a winning combination) of stopped symbols on the video reels 3A-3C. Preferably, winning combinations are assigned to arrangements in which symbols of the same type are aligned on a row (or a diagonal) of the 3×3 symbol matrix on the video reels 3A-3C. The types of winning combinations represent the types of awards. If there is an award linked to the combination of the generated random numbers in the winning combination table, the main controller 11B then checks whether or not the corresponding winning combination appears on one of the selected paylines. If so, the main controller 11B determines that the award is to be provided to the player, and in particular, determines the amount of a payout or the number of available rounds of a bonus game depending on the amount of the bet placed on the payline where the winning combination appears.

After the lottery process and a predetermined time has elapsed from the reception of the spin signal, the main controller 11B causes the display device 11E to display the stopped symbols determined by using the three random numbers on the video reels 3A-3C. If the lottery process causes a player to win a payout, the main controller 11B updates the credit data to increase the credits by the amount of the payout. The main controller 11B further provides the display/speaker driver 11E with commands for producing visual/sound effects, which show the win, by using the touch panel 5, the spin button 6, the display windows 2A and 2B, and the speaker.

At each end of a round, the main controller 11B preferably updates the point data to increase the number of points by the number to be provided to the player depending on the amount of the bets used in the round. The display driver 11E then updates the number of the points displayed on the display window 2A or 2B.

The player tracking unit 12 preferably serves as an interface between the external storage device 8 and the server 20. The player tracking unit 12 in particular uses the individual information stored in the storage device 8 to help the server 20 keep track of the number of points and monetary information.

Referring to FIG. 4, the player tracking unit 12 includes a communication handler 12A, a server interface unit 12B, a storage interface unit 12C, an individual information manager unit 12D, a player monitoring unit 12E, and an alarm unit 12F. The communication handler 12A connects other components 12B-12F to the internal bus 14. The server interface unit 12B preferably serves as a bridge between the internal bus 14 and the LAN 30, and in particular transmits the individual information including the number of points and monetary information to the server 20 through the LAN 30. The storage interface unit 12C preferably uses the pad 7 to communicate with the storage device 8 placed thereon and in particular exchanges the individual information of a player with the storage device 8. The individual information manager unit 12D preferably uses an item of the individual information in identification of the player, or as the monetary information. The player monitoring unit 12E preferably uses the combination of the camera 9 and an image processor as a human sensor to detect a presence or absence of a player and also his/her position from the objects captured by the camera 9 in front of or around the gaming machine 10. The alarm unit 12F preferably monitors the connection between the storage interface unit 12C and the storage device 8. The alarm unit 12F may also monitor the presence or absence of the storage device 8 on the pad 7, e.g., by using a touch sensor embedded in the pad 7. When the connection or the presence is detected, the alarm unit 12F more preferably outputs a warning message or signal depending on game status or in response to a specific signal that the game control unit 11 has received from the player (details will be described below).

When a player starts game play on the gaming machine 10, the player tracking unit 12 preferably performs authentication of the player and the initialization of credit and point data in the following steps.

When the player places his/her storage device 8 on the pad 7, the storage interface unit 12C first establishes connection with the storage device 8. Then, the individual information manager unit 12D reads the individual information from the storage device 8 through the storage interface unit 12C. The individual information manager unit 12D next extracts the ID code assigned to the storage device 8 or the player from the read individual information, and transmits the ID code to the server 20 through the server interface unit 12B. In response to the ID code, the server 20 retrieves the individual information linked to the ID code from the database, and returns a specific item of the identification data included in the individual information. The individual information manager unit 12D then receives the specific item through the server interface unit 12B, and checks it against the corresponding item of the individual information read from the storage device 8. If the items are matched with each other, the individual information manager unit 12D extracts monetary information and point data from the read individual information, and stores them in the memory unit 11C. The main controller 11B then resets credit data and point data in the memory unit 11C on the basis of the stored data. Here, the main controller 11B may allow the player to determine the number of credits to be converted from the monetary information through the touch panel 5. If the items are not matched with each other, the individual information manager unit 12D notifies the game control unit 11, the server 20, and a casino-attendant's device of an authentication error. Then, the game control unit 11 informs the player of the error by using images on the display windows 2A and 2B and sounds from the speaker. In addition, the individual information manager unit 12D disconnects the storage interface unit 12C from the storage device 8. Note that the server 20 may check the specific items of the identification data instead of the individual information manager unit 12D.

When a player quits game play on the gaming machine 10, the player tracking unit 12 preferably stores the monetary information indicating the remaining credits into the storage device 8, and the point data into the server 20 in the following steps.

When the player enters an instruction to quit game play into the console unit 11D, e.g., by pushing a virtual cash-out button displayed on the touch panel 5, the game control unit 11 first causes the player to select how to pay the remaining credits, i.e., by ticket or by monetary information to be stored in the storage device 8. If the console unit 11D accepts the instruction to convert the credits into the monetary information, the individual information manager unit 12D transfers the credit data from the memory unit 11C to the storage device 8 through the storage interface unit 12C. (After that, the credit data will be deleted from the memory unit 11C.) On the other hand, the individual information manager unit 12D transfers the point data together with the ID code to the server 20 through the server interface unit 12B. The server 20 then retrieves the individual information linked to the ID code from the database, and replaces the point data included in the individual information with the new point data received from the individual information manager unit 12D. Thus, the server 20 keeps track of the player's points.

The jackpot controller unit 13 preferably links to the external jackpot controller 40 through the server interface unit 12B and the LAN 30 (cf. FIG. 1). Note that the jackpot controller 40 may be installed in one of the gaming machine 10 as its jackpot controller unit 13. The jackpot controller unit 13 monitors the player's bets accepted by the console unit 11D through the internal bus 14, and informs the external jackpot controller 40 of each bet. The external jackpot controller 40 performs a lottery process each time it receives information for a bet. The lottery process determines whether or not to provide a jackpot. If the external jackpot controller 40 is of a progressive type, it increments a jackpot value by a percentage of every bet until a jackpot has been won. The jackpot controller unit 13 then accesses the external jackpot controller 40 to check the latest jackpot value and whether or not a jackpot has been won. On the other hand, the game control unit 11 queries the jackpot controller unit 13 about the latest jackpot value at each round of a game, and then displays the latest jackpot value on the display window 2A or 2B. If the external jackpot controller 40 determines that one of the gaming machines 10 has won a jackpot, the jackpot controller unit 13 of the targeted gaming machine 10 will detect the jackpot, and then command the game control unit 11 to inform the player of the jackpot by producing specific visual/sound effects, and increase the player's credits by the jackpot value. For example, the game control unit 11 gradually increases the number of credits displayed on the main display window 2A with much fanfare.

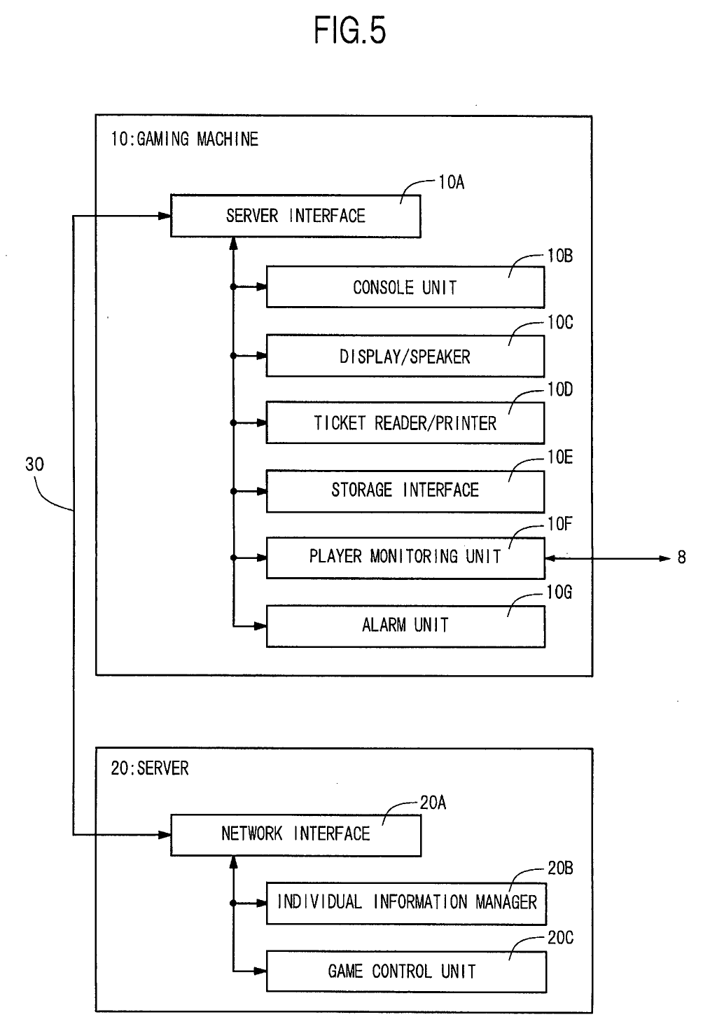

The gaming machine 10 may be of a thin-client type. Referring to FIG. 5, the server interface unit 10A of the gaming machine 10 communicates with a network interface unit 20A of the server 20 through the LAN 30. The server 20 includes an individual information manager unit 20B and a game control unit 20C (in particular, a main controller executing a game program and a memory unit storing the game program), instead of the gaming machine 10. Other functional units 10A-10G are similar to those 11D-11F, 12B, 12C, 12E, and 12F shown in FIG. 4 (details are found in the description about the units 11D-11F, 12B, 12C, 12E, and 12F). The individual information manager unit 20B and the game control unit 20C each emulate the equivalents 11 and 12 shown in FIG. 4. Accordingly, commands and data about game processes are exchanged through the LAN 30. Note that the other functional units 10A-10G included in the gaming machine 10 are preferably integrated in the same control board as shown in FIG. 5, since the units require lower CPU power than the standalone- and download-type gaming machines 10. Alternatively, the units may be divided into two control boards as shown in FIG. 4. In addition, the player monitoring unit 10F and/or the alarm unit 10G may be moved to the server 20. In this case, the player monitoring unit 10F may use surveillance cameras installed in a casino floor and connected to the LAN 30 instead of or in addition to the camera 9.

The alarm unit 12F (or 10G) preferably outputs a warning message or signal indicating that the storage device 8 is still positioned on the pad 7 where the storage device 8 is allowed to communicate with the storage interface unit 12C. The alarm unit 12F preferably outputs the warning message or signal by using the display windows 2A, 2B, the speaker, and/or a lighting unit. Referring to FIG. 6B, the alarm unit 12F preferably superimposes a window 3W showing the warning message upon a game screen 3. The window 3W preferably emerges from the bottom of the game screen 3 (cf. a lower arrow D1), stays at the center thereof, and disappears to the top thereof (cf. an upper arrow D2). Note that the window 3W may be displayed on the game screen 3 in another manner, e.g., moving in a horizontal direction, or appearing at the center of the game screen 3 suddenly or gradually. The warning message may be reproduced as a voice announcement through the speaker. The display windows 2A, 2B, the touch panel 5, the spin button 6, and/or a lighting unit may change brightness and color in a specific pattern that indicates the warning signal. The warning message or signal may be reproduced by the grand display 50, an external speaker, or lighting devices connected to the LAN 30. The alarm unit 12F may transmit the warning message or signal to the server 20 and/or mobile devices that casino attendants own through the LAN 30.

The alarm unit 12F preferably outputs the warning message or signal when it is likely that a player will carelessly leave his/her storage device 8 on the pad 7. Accordingly, the warning message or signal can be provided to a player or a casino attendant at an appropriate time. Thus, the gaming machine 10 can effectively reduce the risk of losing the players' storage devices 8 without bothering the players during game play with unnecessary displays of warning messages or signals.

The alarm unit 12F outputs the warning message or signal preferably when the console unit 11D has accepted the player's instruction to convert his/her credits into cash (i.e., pay the credits by ticket) or the monetary information to be stored in the storage device 8. Here, the console unit 11D preferably accepts the instruction when detecting that a player has touched a virtual cash-out button displayed on the touch panel 5. Alternatively, the alarm unit 12F may output the warning message or signal when the game control unit 11 has ejected a ticket with the player's credits printed thereon, or when the game control unit 11 has finished storing the monetary information into the storage device 8. The conversion is usually performed when a player will quit game play on the gaming machine 10. Accordingly, the warning message or signal can be provided to a player or a casino attendant when the player will quit game play and leave the gaming machine 10.

The alarm unit 12F preferably outputs the warning message or signal depending on whether available credits are reduced to zero or not. Here, the alarm unit 12F preferably checks if credits are reduced to zero by using a usual routine at the end of each round. The alarm unit 12F preferably outputs the warning message or signal in one of the following three cases (A)-(C):

(A) The first case is when the game control unit 11 detects that the player's credits have been reduced to zero at the end of each round of a game.

(B) The second case is when the game control unit 11 has received no additional credits from the player for a predetermined time after detecting that the credits were reduced to zero. Note that the player can enter another ticket into the ticket slot 4, or instruct the game control unit 11 to convert additional credits from the monetary information by using the touch panel 5. When the ticket reader 11F decodes additional credits from a bar code printed on the new ticket, or the console unit 11D accepts the instruction, the main controller 11B updates credit data in the memory unit 11C to add the additional credits to available credits.

(C) The third case is when the game control unit has received from the player the instruction to quit game play after detecting that the credits were reduced to zero. Note that the player can instruct the game control unit 11 to quit game play by using the touch panel 5.

There is a high probability that the player will quit game play and leave the gaming machine 10 in the above-mentioned three cases (A)-(C). Accordingly, the warning message and signal outputted in the cases (A)-(C) are effective at reducing the risk of losing players' storage devices 8.

For a similar reason, the alarm unit 12F may output the warning message or signal depending on whether or not available credits is reduced below a minimum bet (a lowest denomination for each type of game that a player can play on the gaming machine 10). Here, the alarm unit 12F has to check if credits are reduced below the minimum bet by using an additional process appended to a usual routine at the end of each round. The alarm unit 12F preferably outputs the warning message or signal in one of the following three cases (A)-(C):

(A) The first case is when the game control unit 11 detects that the player's credits have been reduced below a minimum bet at the end of each round of a game.

(B) The second case is when the game control unit 11 has received no additional credits from the player for a predetermined time after detecting that the credits were reduced below a minimum bet.

(C) The third case is when the game control unit has received from the player the instruction to quit game play after detecting that the credits were reduced below a minimum bet.

The alarm unit 12F preferably outputs the warning message or signal when the game control unit 11 has received from a player the instruction to suspend game play on the gaming machine 10. The instruction to suspend game play is usually entered through the touch panel 5 when the player intends to take a break from the gaming machine 10. Accordingly, the warning message or signal is effective.

The alarm unit 12F preferably outputs the warning message or signal when the game control unit 11 has determined to provide a player with a larger payout as an award. Alternatively, the alarm unit 12F preferably outputs the warning message or signal when the jackpot controller unit or the external jackpot controller 40 has determined to provide the player with a jackpot. In such cases, it is likely that the player will become distracted from the excitement. If not, there is a high probability that the player will find satisfaction in winning the larger payout or the jackpot and quit game play on the gaming machine 10. Accordingly, the warning message or signal is effective.

When a payout has been won, the game control unit 11 usually displays an increasing number of credits on the main display window 2A as a visual effect. Especially when a larger payout or a jackpot has been won, the number shown on the credit meter is increasing for a longer time. Accordingly, the alarm unit 12F preferably outputs the warning message or signal when the game control unit 11 increases the credit meter by the amount of the larger payout or the jackpot. Alternatively, the alarm unit 12F may output the warning message or signal when the game control unit 11 has finished increasing of the credit meter or when the game control unit 11 has not received instructions from the player for a predetermined time after the game control unit 11 has started or finished the increase of the credit meter.

The alarm unit 12F preferably outputs the warning message or signal when the game control unit 111 receives a predetermined type of intervention from a player. The types of interventions preferably include the action that indicates the player's annoyance, e.g., striking the touch panel 5 or the spin button 6 repeatedly, accelerating a play time per round, and skipping the display of messages. Preferably, the console unit 11D detects the interventions from patterns of signals accepted through the touch panel 5 and the spin button 6. More preferably, the alarm unit 12F outputs the warning message or signal when the game control unit 11 receives the intervention a predetermined number of times within a fixed time period, or when the game control unit 11 detects both the intervention and that the amount of the player's credit has been reduced below a lower limit, e.g., zero or a minimum bet. When such a type of intervention has occurred frequently or at a time of short credits, there is a high probability that the player intends to quit game play and leave the gaming machine 10. Accordingly, the warning message or signal is effective.

The alarm unit 12F preferably outputs the warning message or signal when the storage interface unit 12C maintains the connection with the storage device 8 active for a predetermined time. When the predetermined time has elapsed from the start of game play, there is a higher probability that a player will quit game play and leave the gaming machine 10. Accordingly, the warning message or signal is effective. In this case, the alarm unit 12F more preferably outputs the warning message or signal when the game control unit 11 has not received instructions from the player for the predetermined time. Under this condition, the player is probably not concentrating on the game. Accordingly, the warning message or signal (in particular, by voice or sound) is effective. Note that the alarm unit 12F or the game control unit 11 may leave the time period of playing a feature or bonus game out of measuring the predetermined time, since, in general, there is a lower probability that a player will quit game play and leave the gaming machine 10 on which the player has experienced feature and bonus games for a long time.

The alarm unit 12F preferably outputs the warning message or signal when the storage interface unit 12C has detected an error in the communication with the storage device 8, and the game control unit 11 has received from the player no instruction for a predetermined time after the detection of the error. Under this condition, the player is probably unaware of the error in the storage device 8. In this case, it is likely that the player will carelessly leave his/her storage device 8 on the pad 7. Accordingly, the warning message or signal is effective.

The alarm unit 12F preferably outputs the warning message or signal when the game control unit 11 has been forced to terminate a game because of an error. Under this condition, the player usually has no other choice but to leave the gaming machine 10. Accordingly, the warning message or signal is effective.

The alarm unit 12F preferably determines whether to output the warning message or signal depending on the position of a player detected by using the player monitoring unit 12E. In particular, the alarm unit 12F outputs the warning message or signal when the player monitoring unit 12E has detected that a player is absent in front of or around the cabinet 1, or when the player is some distance from the cabinet 1. This is effective in quickly notifying the player or a casino attendant of carelessly leaving the player's storage device 8 on the pad 7.

The alarm unit 12F preferably transmits the warning message or signal to the ticket printer driver 11F. The ticket printer driver 11F then prints the warning message or a specific symbol as the warning signal on a ticket which is then provided to a player from the ticket slot 4. The player rarely forgets the ticket when he/she leaves the gaming machine 10 since the ticket is the equivalent of cash to the player. Accordingly, the warning message or signal printed on the ticket is effective.

The alarm unit 12F preferably stops outputting the warning message and signal when the storage interface unit 12C has cut off the connection with the storage device 8. This allows the alarm unit 12F not only to reduce the power consumption, but also to prevent the unnecessary warning messages or signals from bothering a player during game play.

The alarm unit 12F preferably uses the individual information to output the warning message or signal.

For example, the alarm unit 12F reads a targeted player's name or face photograph from the individual information manager unit 12D, and uses them in the warning message or signal. Then, the player's name or face photograph appears in the warning message window 3W on the main display window 2A or the grand display 50. Alternatively, the player's name is reproduced by voice together with the warning message. Accordingly, the player can quickly recognize that the warning is aimed at him/her.

The alarm unit 12F may read a phone number and/or an email address from the individual information manager unit 12D, and use it to send the warning message or signal to a player's mobile phone by phone call or email. If the storage device 8 itself has the function of receiving a phone call or email from a network, i.e., the storage device 8 is a mobile phone 8A or a PDA 8B, the alarm unit 12F may send the warning message or signal to the storage device 8 directly. A targeted player can quickly recognize the warning by ring/message alert, blinking light, or silent vibration. In recent years, there are types of mobile phones and PDAs capable of notifying a small wearable gadget of an incoming call or email in a wireless manner. The gadget is attached to or embedded in user's clothes, key ring, finger ring, or glasses, and notifies the user of an incoming call or email by a beep or vibration. The alarm unit 12F may use the gadget to notify of the warning message or signal.

The alarm unit 12F may read a targeted player's name or face photograph from the individual information manager unit 12D, and send them with the warning message or signal to the server 20 and/or a device of a casino attendant. Then, the attendant can quickly identify the targeted player among people in a casino floor.

### General Interpretation of Terms

In understanding the scope of the present invention, the term “configured” as used herein to describe a component, section or portion of a device includes hardware and/or software that is constructed and/or programmed to carry out the desired function. In understanding the scope of the present invention, the term “comprising” and its derivatives, as used herein, are intended to be open ended terms that specify the presence of the stated features, elements, components, groups, integers, and/or steps, but do not exclude the presence of other unstated features, elements, components, groups, integers and/or steps. The foregoing also applies to words having similar meanings such as the terms, “including”, “having” and their derivatives. Also, the terms “unit,” “section,” “portion,” “member” or “element” when used in the singular can have the dual meaning of a single portion or a plurality of portions. Finally, terms of degree such as “substantially”, “about” and “approximately” as used herein mean a reasonable amount of deviation of the modified term such that the end result is not significantly changed. For example, these terms can be construed as including a deviation of at least ±5% of the modified term if this deviation would not negate the meaning of the word it modifies.

While only a preferred embodiment has been chosen to illustrate the present invention, it will be apparent to those skilled in the art from this disclosure that various changes and modifications can be made herein without departing from the scope of the invention as defined in the appended claims. Furthermore, the foregoing description of the preferred embodiment according to the present invention is provided for illustration only, and not for the purpose of limiting the invention as defined by the appended claims and their equivalents.

What is claimed is:

1. A gaming machine comprising:
a storage interface unit configured to communicate with an external storage device to exchange individual information of a player;
an individual information manager unit configured to use an item of the individual information as an identification of the player or as monetary information relating to game play;
a game control unit configured to execute a game program, control game functions depending on data entered by the player, and change the monetary information depending on a game result; and
an alarm unit configured to output a warning message or signal indicating that the external storage device is positioned where it is able to communicate with the storage interface unit in response to a game status or in response to a specific signal that the game control unit has received from the player.

2. The gaming machine according to claim 1, wherein
the storage interface unit includes one of a pad, a slot, and a holder, which is configured to communicate with the external storage device that is placed thereon or therein, and
the alarm unit is configured to monitor a connection between the storage interface unit and the external storage device, or the presence or absence of the external storage device relative to the storage interface unit.

3. The gaming machine according to claim 1, wherein
the alarm unit is further configured to output the warning message or signal when the game control unit has received an instruction to convert player's credits into cash or the monetary information to be stored in the external storage device, or when the game control unit has finished converting the player's credits into cash or the monetary information.

4. The gaming machine according to claim 1, wherein
the alarm unit is further configured to output the warning message or signal in one of the following cases: when the game control unit detects that the player's credits have been reduced to zero; when the game control unit has received no additional credits from the player for a predetermined time after detecting that the player's credits were reduced to zero; and when the game control unit has received an instruction to quit game play after detecting that the player's credits were reduced to zero.

5. The gaming machine according to claim 1, wherein
the alarm unit is further configured to output the warning message or signal in one of the following cases: when the game control unit detects that the player's credits have been reduced below a minimum bet; when the game control unit has received no additional credits from the player for a predetermined time after detecting that the player's credits were reduced below the minimum bet; and when the game control unit has received an instruction to quit game play after detecting that the player's credits were reduced below the minimum bet.

6. The gaming machine according to claim 1, wherein
the alarm unit is further configured to output the warning message or signal when the game control unit has received an instruction to suspend game play.

7. The gaming machine according to claim 1, wherein
the alarm unit is further configured to output the warning message or signal when the game control unit has determined to provide the player with a jackpot or an award larger than a predetermined amount.

8. The gaming machine according to claim 7 further comprising
a display unit configured to display a credit meter from the game control unit, the alarm unit being further configured to output the warning message or signal in one of the following cases: when the game control unit increases the credit meter by the amount of the jackpot or the award; when the game control unit has finished increasing the credit meter; and when the game control unit has not received an instruction during a predetermined time after the game control unit has started or finished increasing the credit meter.

9. The gaming machine according to claim 1, wherein
the alarm unit is further configured to output the warning message or signal when a jackpot controller has determined to provide the player with a jackpot.

10. The gaming machine according to claim 9 further comprising
a display unit configured to display a credit meter from the game control unit, the alarm unit being further configured to output the warning message or signal in one of the following cases: when the game control unit increases the credit meter by an amount of the jackpot; when the game control unit has finished increasing the credit meter; and when the game control unit has not received an instruction during a predetermined time after the game control unit has started or finished increasing the credit meter.

11. The gaming machine according to claim 1, wherein
the alarm unit is further configured to output the warning message or signal when the game control unit receives a predetermined type of intervention.

12. The gaming machine according to claim 11, wherein
the alarm unit is further configured to output the warning message or signal when the game control unit receives the predetermined type of intervention a predetermined number of times within a fixed time period, or when the game control unit detects both the intervention and that an amount of the player's credit has been reduced below a lower limit.

13. The gaming machine according to claim 1, wherein
the alarm unit is further configured to output the warning message or signal when the storage interface unit maintains a connection with the external storage device for a predetermined time.

14. The gaming machine according to claim 13, wherein
the alarm unit is further configured to output the warning message or signal when the game control unit has not received an instruction for the predetermined time.

15. The gaming machine according to claim 1, wherein
the alarm unit is further configured to output the warning message or signal when the storage interface unit has detected an error in communication with the external storage device and the game control unit has not received an instruction for a predetermined time after the detection of the error.

16. The gaming machine according to claim 1, wherein
the alarm unit is further configured to output the warning message or signal when the game control unit has been forced to terminate a game because of an error.

17. The gaming machine according to the claim 1 further comprising
a human sensor or a player monitoring unit having a camera or an image processor, the alarm unit being further configured to determine whether to output the warning message or signal depending on a position of the player detected by the human sensor or the player monitoring unit.

18. The gaming machine according to claim 1 further comprising
one of a display unit, a speaker, and a lighting unit, the alarm unit being further configured to output the warning message or signal by using the display unit or the speaker, or change the brightness and color of the lighting unit in specific patterns.

19. The gaming machine according to claim 1, wherein
the alarm unit is further configured to output the warning message or signal to an external display device or an external speaker, or change the brightness and color of an internal lighting device in specific patterns.

20. The gaming machine according to claim 1, wherein
the alarm unit is further configured to transmit the warning message or signal to a specific device through a network.

21. The gaming machine according to claim 1 further comprising
a ticket reader unit configured to receive a ticket from a player, and decode monetary information from data printed on the ticket; and
a ticket printer unit configured to print data indicating monetary information on a new ticket or the ticket received in the ticket reader unit,
the alarm unit being further configured to transmit the warning message or signal to the ticket printer unit, and the ticket printer unit being further configured to print the warning message or a specific symbol as the signal on the new ticket or the ticket received in the ticket reader unit.

22. The gaming machine according to claim 1, wherein
the alarm unit is further configured to stop outputting the warning message or signal when the storage interface unit has cut off a connection with the external storage device.

23. The gaming machine according to claim 1, wherein
the alarm unit is further configured to use the individual information to output the warning message or signal.

24. A gaming system comprising:
a server including a memory unit configured to store a game program; and
a gaming machine configured to communicate with the server,
the gaming machine including
a storage interface unit configured to communicate with an external storage device to exchange individual information of a player,
an individual information manager unit configured to use an item of the individual information as an identification of the player or as monetary information relating to game play,
a game control unit configured to download the game program from the memory unit, execute the game program, control game functions depending on data entered by the player, and change the monetary information depending on a game result, and
an alarm unit configured to output a warning message or signal indicating that the external storage device is positioned where it is able to communicate with the storage interface unit in response to a game status or in response to a specific signal that the game control unit has received from the player.

25. The gaming system according to claim 24 further comprising
one of a display device, a speaker, and a lighting device connected to the gaming machine, the alarm unit being further configured to output the warning message or signal by using the display device or the speaker, or change the brightness and color of the lighting device in specific patterns.

26. A gaming system comprising:
a server; and
a gaming machine configured to communicate with the server
the server including
an individual information manager unit configured to use individual information of a player who plays a game on the gaming machine in identification of the player, or as monetary information relating to game play, and
a game control unit configured to execute a game program, receive instructions and input data from the gaming machine entered by the player, provide the gaming machine with commands and output data to control game functions depending on the instructions and input data, and change the monetary information depending on a game result, and
the gaming machine including
a storage interface unit configured to communicate with an external storage device to exchange the individual information of the player,
a server interface unit configured to transmit the individual information and the instructions and input data to the game control unit, and receive the commands and output data from the game control unit to cause the gaming machine to perform game functions depending on the commands and output data, and
an alarm unit configured to output a warning message or signal indicating that the external storage device is positioned where it is able to communicate with the storage interface unit in response to a game status or in response to a specific signal that the game control unit has received from the player.

27. The gaming system according to claim 26 further comprising
one of a display device, a speaker, and a lighting device connected to the gaming machine, the alarm unit being further configured to output the warning message or signal by using the display device or the speaker, or change the brightness and color of the lighting device in specific patterns.
